(19) United States
(12) Patent Application Publication
(10) Pub. No.: US 2003/0227542 A1
(43) Pub. Date: Dec. 11, 2003

(54) Single-computer real-time stereo augmented reality system

(76) Inventors: Xiang Zhang, Lawrenceville, NJ (US); Nassir Navab, Plainsboro, NJ (US); Yakup Genc, Plainsboro, NJ (US)

Correspondence Address: Siemens Corporation, Intellectual Property Department, 186 Wood Avenue South, Iselin, NJ, 08830, US

(21) Appl. No.: 10/324,191

(22) Filed: Dec. 20, 2002

Related U.S. Application Data
(60) Provisional application No. 60/343,008, filed on Dec. 20, 2001.

(51) Int. Cl. H04N 7/18; H04N 9/47

(52) U.S. Cl. 348/61

(57) ABSTRACT

A single-computer real-time augmented reality system includes a computer having a processor coupled in signal communication with a PCI bus, a head-mounted display coupled with the computer, a first frame grabber disposed relative to the computer and coupled with the processor, the first frame grabber having a direct digital video output, a left video camera disposed relative to the head-mounted display and coupled with the first frame grabber, a left video display disposed relative to the head-mounted display and coupled with the direct video output of the first frame grabber, a second frame grabber disposed relative to the computer and coupled with the processor, the second frame grabber having a direct digital video output, a right video camera disposed relative to the head-mounted display and coupled with the second frame grabber, and a right video display disposed relative to the head-mounted display and coupled with the direct video output of the second frame grabber.

This application claims priority to U.S. Provisional application serial No. 60/343,008 by Xiang Zhang filed Dec. 20, 2001.

### BACKGROUND

Augmented reality (“AR”) systems with stereo video-see-through head-mounted-displays (“HMD”) need to process and display at least two streams of video data in real-time. Typically, stereo AR systems use at least two computers to drive the video. The video digitizer may be a Peripheral Component Interconnect bus (“PCI”) frame grabber. Within each computer, all the PCI plug-in devices, such as the frame grabber, are connected to the system through the PCI bus. The capacity of the PCI bus of an ordinary personal computer (“PC”) is not enough for 2 real-time (e.g., 30 frames/second) 24-bit color full-size (e.g., 640×480) video streams. Therefore, at least two computers, each equipped with a special PCI device frame grabber, or two computers with special graphics and/or imaging capabilities such as, for example, Silicon Graphics, Inc. (“SGI”) O2 workstation computers, are needed to drive such an AR system with stereo video-see-through. Thus, the stereo AR systems are typically large in size due to the need for dual computers, and costly, such as, for example, for 2 SGI computers, cameras, and a video-see-through HMD.

Having to use more than one computer to drive one stereo AR system also introduces a system synchronization problem. To synchronize the image processing and the virtual object overlays, a network connection among the driving computers is typically required, and thus extra programming effort is needed for the corresponding software.

### SUMMARY

These and other drawbacks and disadvantages of the prior art are addressed by a Single-Computer Real-Time Augmented Reality System.

A single-computer real-time augmented reality system includes a computer having a processor coupled in signal communication with a PCI bus, a head-mounted display coupled with the computer, a first frame grabber disposed relative to the computer and coupled with the processor, the first frame grabber having a direct video output, a left video camera disposed relative to the head-mounted display and coupled with the first frame grabber, a left video display disposed relative to the head-mounted display and coupled with the direct video output of the first frame grabber, a second frame grabber disposed relative to the computer and coupled with the processor, the second frame grabber having a direct video output, a right video camera disposed relative to the head-mounted display and coupled with the second frame grabber, and a right video display disposed relative to the head-mounted display and coupled with the direct video output of the second frame grabber. In embodiments where a separate tracking camera is used, an additional third frame grabber is disposed relative to the computer and coupled with the bus, and the tracking camera is disposed relative to the head-mounted display and coupled with the third frame grabber.

A corresponding method for providing augmented reality in real-time using a single computer includes tracking the motion of the HMD, either by capturing infrared tracking video data reflected from a tracking marker to a tracking frame acquisition unit, or by directly processing the video frames captured by one of the left and right cameras, then computing pose estimation results for the motion tracking and passing the results to left and right frame acquisition units, capturing left and right video data to the left and right frame acquisition units, respectively, passing the acquired left and right video data through the on-board display buffers of the respective frame acquisition units and out to their direct video outputs, applying the pose estimation results to the rendering of virtual objects on each of the left and right frame acquisition units for an augmented reality overlay, and displaying the left and right video data with augmented reality overlays in real-time.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a Single-Computer Real-Time Augmented Reality System in accordance with the following exemplary figures, in which:

FIG. 1 shows a schematic signal diagram for an augmented reality system according to an illustrative embodiment of the present disclosure;

FIG. 2 shows a perspective diagram for a stereo video-see-through head-mounted-display usable with the system of FIG. 1;

FIG. 3 shows an oblique partial perspective diagram for a personal computer expansion slot portion configured for the system of FIG. 1;

FIG. 4 shows a front perspective diagram of motion tracking and system calibration markers usable with the system of FIG. 1; and

FIG. 5 shows a schematic signal diagram for an augmented reality system according to another illustrative embodiment of the present disclosure.

### DETAILED DESCRIPTION OF PREFERRED EMBODIMENTS

The present disclosure teaches a Single-Computer Real-Time Augmented Reality System. In an exemplary embodiment, a single personal computer (“PC”) is used to drive an augmented reality (“AR”) system having a stereo video-see-through head mounted display (“HMD”), which displays stereo video streams in real-time. The system occupies less space, and is also less expensive, than typical dual-computer stereo AR systems. The presently disclosed AR system has application in many areas, including, for example, industry and medical care.

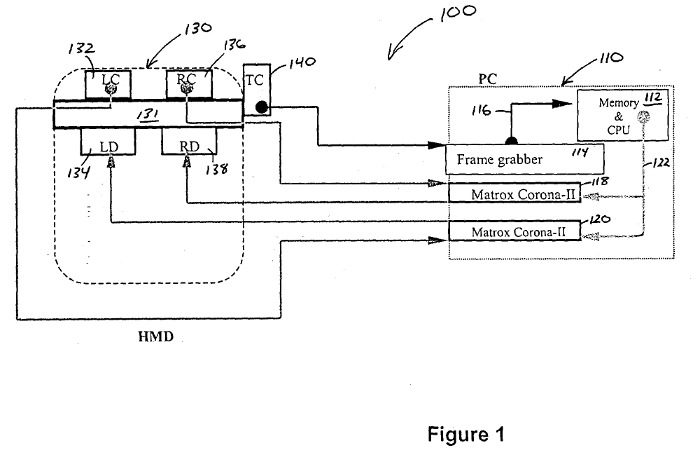

As shown in FIG. 1, an exemplary AR system is indicated generally by the reference numeral 100. The AR system 100 includes a PC 110. The PC 110 includes a motherboard 112 with modest computing power, such as, for example, a CPU with a processing speed above about 400 MHz and random access memory above about 256 MB. The PC also includes a standard Peripheral Component Interconnect bus (“PCI”) frame acquisition unit or frame grabber card 114 coupled in signal communication to the motherboard 112 via a PCI bus 116. The standard frame grabber card 114 may be, for example, a Falcon frame grabber card, or any other PCI bus frame grabber card suitable for use with the infrared tracking camera. The PC 110 further includes first and second Matrox Corona-II® frame acquisition or grabber cards, 118 and 120, respectively, which each have a direct VGA output and are controllably coupled in signal communication to the motherboard via a bus 122.

The exemplary AR system 100 further includes a video-see-through HMD 130 with stereo VGA displays, for example. The HMD 130 includes a support member 131, adjustably shaped to fit a user's head. The HMD 130 includes a left video camera (“LC”) 132 and a right video camera (“RC”) 136, each attached to the support member 131. The RC 136 is coupled in signal communication to the first frame grabber 118, while the LC 132 is coupled in signal communication to the second frame grabber 120. The HMD 130 also includes a left display (“LD”) 134 and a right display (“RD”) 138, each attached to the support member 131. The RD 138 is coupled in signal communication to and driven by the dedicated VGA output of the first frame grabber 118, while the LD 134 is coupled in signal communication to and driven by the dedicated VGA output of the second frame grabber 120. The HMD 130 further includes an optional infrared motion-tracking camera (“TC”) 140 attached to the support member 131, which is coupled in signal communication to the PCI frame grabber 114.

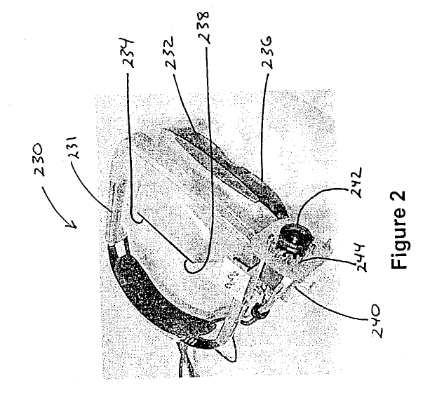

Turning to FIG. 2, a stereo video-see-through head-mounted-display (“HMD”) usable with the system of FIG. 1 is indicated generally by the reference numeral 230. The HMD 230 includes a support member 231, adjustably shaped to fit a user's head. The HMD 230 includes a left video camera (“LC”) 232 and a right video camera (“RC”) 236, each attached to the support member 231. The HMD 230 also includes a left display (“LD”) 234 and a right display (“RD”) 238, each attached to the support member 231. The HMD 230 further includes an infrared motion-tracking camera (“TC”) 240 attached to the support member 231. The TC 240 includes an infrared filter 242 and an infrared LED panel 244 mounted relative to the TC 240.

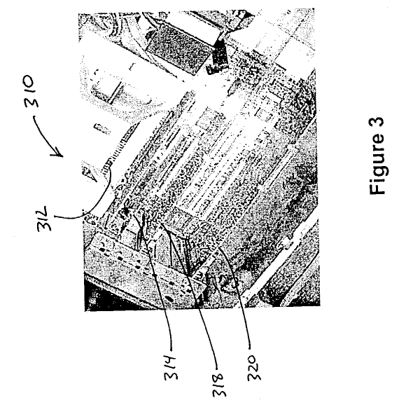

Referring to FIG. 3, a personal computer expansion slot portion configured for the system of FIG. 1 is indicated generally by the reference numeral 310. The PC portion 310 includes a motherboard 312, a standard Peripheral Component Interconnect bus (“PCI”) frame grabber card 314 coupled in signal communication to the motherboard 312, and first and second Matrox Corona-II® frame grabber cards, 318 and 320, respectively, which each have a direct VGA output and are controllably coupled in signal communication to the motherboard 312.

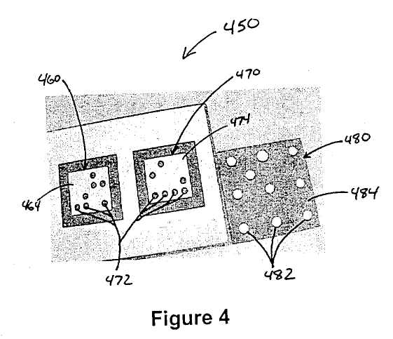

Turning now to FIG. 4, motion tracking and system calibration markers usable with the system of FIG. 1 are indicated generally by the reference numeral 450. The markers 460 and 470 are for calibrating the left and right cameras respectively, and comprise dark dots 472 on light backgrounds 464 and 474, respectively. The marker 480 is for calibrating the infrared tracking and comprises light dots 482, for reflecting infrared light, disposed on a dark background 484.

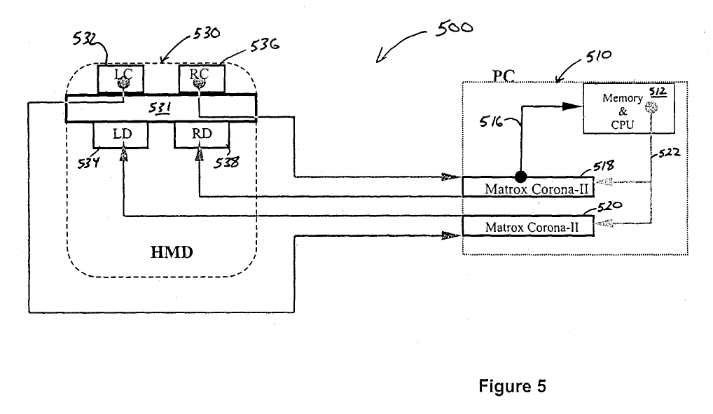

FIG. 5 shows another exemplary embodiment configuration of a real-time stereo AR system indicated generally by the reference numeral 500. The real-time stereo AR system 500 is similar to the system 100 of FIG. 1, a difference being that the AR system 500 does not include an infrared tracking camera. In this case, a video frame captured by one of the video cameras LC and/or RC is passed through the PCI bus to the computer for motion tracking using any one of the known algorithms, where tracking may be based on visual rather than infrared markers, or alternatively feature based.

The AR system 500 includes a PC 510. The PC 510 includes a motherboard 512 with modest computing power, such as, for example, a CPU with a processing speed above about 400 MHz and random access memory above about 256 MB. The PC also includes a bus 516, such as, for example, a standard Peripheral Component Interconnect (“PCI”) bus, coupled in signal communication to the motherboard 512. The PC 510 further includes first and second Matrox Corona-II® frame acquisition or grabber cards, 518 and 520, respectively, which each have a direct VGA output and are controllably coupled in signal communication to the motherboard via a bus 522. It shall be understood that the Matrox Corona-II® frame grabber cards 518 and 520 may be substituted by other suitable frame acquisition units having direct video outputs that may become available.

The exemplary AR system 500 further includes a video-see-through HMD 530 with stereo VGA displays, for example. The HMD 530 includes a support member 531, adjustably shaped to fit a user's head. The HMD 530 includes a left video camera (“LC”) 532 and a right video camera (“RC”) 536, each attached to the support member 531. The RC 536 is coupled in signal communication to the first frame grabber 518, while the LC 532 is coupled in signal communication to the second frame grabber 520. The HMD 530 also includes a left display (“LD”) 534 and a right display (“RD”) 538, each attached to the support member 531. The RD 538 is coupled in signal communication to and driven by the dedicated VGA output of the first frame grabber 518, while the LD 534 is coupled in signal communication to and driven by the dedicated VGA output of the second frame grabber 520.

In operation, the video cameras LC and RC capture the video to the Corona-II boards, the grabbed video data-are passed to the Corona-II on-board display buffer and displayed on the HMD through the Corona-IIs' on-board VGA outputs. Since each Corona-II board has an on-board graphic chip and a built-in VGA output connector, the captured video data are not passed through the PCI bus, and thus do not affect the data traffic on the PCI bus. When the AR system 100 of FIG. 1 is used, the attached camera with infrared filter captures the infrared reflected from the tracking marker. Here, only the tracking video data is passed through the PCI bus to the memory of the computer for motion tracking, as will be understood by those of ordinary skill in the pertinent art. The results of the pose estimation are used for the rendering of virtual objects on each Corona-II board for the AR overlay. Since only the one infrared video data stream passes through the PCI bus, the AR process can be achieved in real-time.

Tracking and system calibration for the AR system is accomplished by any one of a number of methods known in the art. In the embodiment 100 of FIG. 1, a marker made of infrared reflectors for motion tracking can be used, as shown in FIG. 4. The tracking camera is pre-calibrated for its internal parameters, and the pose of the tracking camera related to the infrared marker can be computed using the homography between the infrared marker and its image correspondences. Therefore, the poses of the video cameras can then be obtained with known system calibration results.

The system calibration computes the transformation from the tracking camera coordinate system to the video cameras' coordinate systems. This is accomplished by first calibrating the internal parameters of the video cameras. Then the infrared marker is used together with the coded visual markers, as shown in FIG. 3, for the system calibration. The positions of the visual markers related to the infrared marker are given. Thus, the poses of the video cameras can also be computed from the homography of the feature points of the visual markers and their image correspondences, as understood in the art.

In the cases where an infrared tracking camera is not used, such as in the AR system 500 of FIG. 5, either of the video cameras is also used as the motion-tracking camera. The tracking is accomplished by any one of a number of methods known in the art. For example, one way is to do the tracking and pose estimation based on coded visual markers rather than infrared markers, or natural features of the captured scene. The system calibration is accomplished off-real-time using any one of the methods known in the art to compute the internal parameters of the camera and the transformation from the coordination system of one camera to that of the other.

Virtual object overlay is performed by the Matrox Corona-II® boards, which provide a non-destructive overlay buffer on each board. Therefore, the AR overlay can be achieved by rendering the virtual objects in this overlay buffer, with a background set to be a transparent key-color. A commercially available software package, such as, for example, MIL-LITE® from Matrox Corporation, can be used to obtain the address of the on-board overlay buffer and the corresponding DirectX rendering surface. MIL-LITE® also provides 2D graphic interface functions that allow the user to directly render text and 2D objects in the overlay buffer. Users may program their own 3D graphics rendering functions to make use of the on-board graphics accelerator to render 3D objects in the overlay buffer using OpenGL or Direct3D in real-time.

Accordingly, AR System motion tracking and system calibration is accomplished by pre-calibrating the cameras for their internal parameters, using the markers to calibrate the system for the transformation between the tracking camera and the video cameras, and tracking the infrared reflecting marker for the virtual object overlay.

Thus, a single-PC-driven AR system with stereo video-see-through HMD is provided that uses a single PC to handle three video data streams, where two of the streams are for stereo video and one of the streams is for visual tracking. The exemplary system provides 640×480 video, display, tracking, and object overlay, all in real-time.

Since the capacity of the PCI bus is limited, the disclosed method for a single PC to handle three real-time VGA video streams includes the use of the Matrox Corona-II® frame grabbers, or like frame grabber cards with direct VGA outputs, which allows the video data to be passed to the on-board VGA output without going through the PCI bus. Therefore, two Corona-II cards can be used to capture and display the stereo video. A Falcon frame grabber is used for the infrared tracking camera, although any other like frame grabber may be substituted without loss of functionality. The overlay is implemented using the Corona-II's non-destructive overlay buffer.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A single-computer real-time augmented reality system comprising:
a computer having a processor and a bus, the processor in signal communication with the bus;
a head-mounted display in signal communication with the computer;
a first frame acquisition unit disposed relative to the computer and in signal communication with the processor, the first frame acquisition unit having a direct video output;
a left video camera disposed relative to the head-mounted display and in signal communication with the first frame acquisition unit;
a left video display disposed relative to the head-mounted display and in signal communication with the direct video output of the first frame acquisition unit;
a second frame acquisition unit disposed relative to the computer and in signal communication with the processor, the second frame acquisition unit having a direct video output;
a right video camera disposed relative to the head-mounted display and in signal communication with the second frame acquisition unit; and
a right video display disposed relative to the head-mounted display and in signal communication with the direct video output of the second frame acquisition unit.

2. An augmented reality system as defined in claim 1, further comprising:
a third frame acquisition unit disposed relative to the computer and in signal communication with the bus; and
a tracking camera disposed relative to the head-mounted display and in signal communication with the third frame acquisition unit.

3. An augmented reality system as defined in claim 1 wherein the computer is a personal computer.

4. An augmented reality system as defined in claim 1 wherein the processor operates at or above about 400 MHz.

5. An augmented reality system as defined in claim 1, further comprising at least about 256 MB of random access memory disposed relative to the computer and in signal communication with the processor.

6. An augmented reality system as defined in claim 1 wherein the bus is a Peripheral Component Interconnect bus.

7. An augmented reality system as defined in claim 1 wherein the direct video outputs are VGA outputs.

8. An augmented reality system as defined in claim 1 wherein the left and right video displays are VGA displays with at least about 24-bit color and at least about 640×480 pixel resolution.

9. An augmented reality system as defined in claim 1 wherein real-time comprises about 30 frames per second per video display.

10. An augmented reality system as defined in claim 1 wherein each of the first and second frame acquisition units comprises a Matrox Corona-II® frame grabber card.

11. An augmented reality system as defined in claim 2 wherein the tracking camera comprises an infrared video camera.

12. A method for providing augmented reality in real-time using a single computer, the method comprising:
capturing tracking video data;
passing tracking video data through a bus to a computer memory for motion tracking;
computing pose estimation results for the motion tracking and passing the results to left and right frame acquisition units;
capturing left and right video data to the left and right frame acquisition units, respectively;
passing the acquired left and right video data through the on-board display buffers of the respective frame acquisition units and out to their direct video outputs;
applying the pose estimation results to the rendering of virtual objects on each of the left and right frame acquisition units for an augmented reality overlay; and
displaying the left and right video data with augmented reality overlays in real-time.

13. A method as defined in claim 12 wherein the tracking video data is reflected from a tracking marker.

14. A method as defined in claim 12 wherein the tracking video data is captured to a tracking frame acquisition unit.

15. A method as defined in claim 12 wherein the tracking video data is infrared.

16. A method as defined in claim 12 wherein the tracking video data is captured by at least one of a left video camera, a right video camera, and a tracking camera.

17. A method as defined in claim 12, further comprising:
using a marker made of infrared reflectors for motion tracking;
pre-calibrating a tracking camera for its internal parameters;
computing the pose of the tracking camera related to the infrared marker using the homography between the infrared marker and its image correspondences; and
obtaining the poses of left and right video cameras with the known system calibration results.

18. A method as defined in claim 17, further comprising:
calibrating the internal parameters of the left and right video cameras using an infrared marker together with coded visual markers;
computing the transformations from the tracking camera coordinate system to the left and right video camera coordinate systems for system calibration; and
computing the poses of the left and right video cameras from the homography of the feature points of the visual markers and their image correspondences.

19. A method as defined in claim 18, further comprising:
performing virtual object overlays within a non-destructive overlay buffer on each of the left and right frame acquisition units; and
rendering the virtual objects in the overlay buffers, with a background set to be a transparent key-color, to achieve the augmented reality overlays.

20. A method as defined in claim 19, further comprising:
obtaining the addresses of the on-board overlay buffers and corresponding rendering surfaces; and
directly rendering at least one of text and 2D objects in the overlay buffers.

21. A method as defined in claim 19, further comprising:
obtaining the addresses of the on-board overlay buffers and corresponding rendering surfaces;
programming an on-board graphics accelerator to render 3D objects in the overlay buffers in real-time.

22. A method as defined in claim 12, further comprising:
pre-calibrating a plurality of cameras for their internal parameters;
using markers to calibrate a system for the transformation between an infrared tracking camera and a plurality of video cameras; and
tracking an infrared reflecting marker for a virtual object overlay.

23. A single-computer real-time augmented reality system comprising:
bus means for passing tracking video data through a bus to a computer memory for motion tracking;
processor means for computing pose estimation results for the motion tracking and passing the results to left and right frame acquisition units;
left and right video camera means for capturing left and right video data to the left and right frame acquisition units, respectively;
overlay means for applying the pose estimation results to the rendering of virtual objects on each of the left and right frame acquisition units for an augmented reality overlay;
direct video output means for passing the acquired left and right video data through the on-board display buffers of the respective frame acquisition units and out to their direct video outputs; and
head-mounted display means for displaying the left and right video data with augmented reality overlays in real-time.

24. A program storage device readable by machine, tangibly embodying a program of instructions executable by the machine to perform program steps for single-computer real-time augmented reality, the program steps comprising:
passing tracking video data through a bus to a computer memory for motion tracking;
computing pose estimation results for the motion tracking and passing the results to left and right frame acquisition units;
capturing left and right video data to the left and right frame acquisition units, respectively;
passing the acquired left and right video data through the on-board display buffers of the respective frame acquisition units and out to their direct video outputs;
applying the pose estimation results to the rendering of virtual objects on each of the left and right frame acquisition units for an augmented reality overlay; and
displaying the left and right video data with augmented reality overlays in real-time.

25. A program storage device as defined in claim 19, the program steps further comprising:
pre-calibrating a plurality of cameras for their internal parameters;
using markers to calibrate a system for the transformation between a tracking camera and at least one video camera; and
tracking a reflecting marker for a virtual object overlay.
